(19) United States
(12) Patent Application Publication
(10) Pub. No.: US 2019/0260831 A1
(43) Pub. Date: Aug. 22, 2019

(54) DISTRIBUTED INTEGRATED FABRIC

(71) Applicant: General Electric Company, Schenectady, NY (US)

(72) Inventors: Roberto MILEV, Walnut Creek, CA (US); Marc-Thomas SCHMIDT, Danville, CA (US)

(21) Appl. No.: 15/902,160

(22) Filed: Feb. 22, 2018

(51) Int. Cl. H04L 29/08; G06Q 10/06

(52) U.S. Cl. CPC H04L 67/125; G06Q 10/063

(57) ABSTRACT

The example embodiments are directed to a system and method for implementing a distributed integrated fabric for digital twin runtime. In one example, the method may include one or more of receiving an asynchronous message from an edge system that is associated with an asset included on an edge of an IoT network, determining an event to be executed with respect to a virtual asset in response to the received asynchronous message, the virtual asset being hosted by a cloud platform of the IoT network, identifying input data for executing of the determined event based on parameters in the received asynchronous message, and triggering execution of the event at the virtual asset hosted by the cloud platform based on the identified input data.

### BACKGROUND

Machine and equipment assets are engineered to perform particular tasks as part of a business process. For example, assets can include, among other things and without limitation, industrial manufacturing equipment on a production line, drilling equipment for use in mining operations, wind turbines that generate electricity on a wind farm, transportation vehicles, and the like. As another example, assets may include devices that aid in diagnosing patients such as imaging devices (e.g., X-ray or MM systems), monitoring equipment, and the like. The design and implementation of these assets often takes into account both the physics of the task at hand, as well as the environment in which such assets are configured to operate.

Low-level software and hardware-based controllers have long been used to drive machine and equipment assets. However, the rise of inexpensive cloud computing, increasing sensor capabilities, and decreasing sensor costs, as well as the proliferation of mobile technologies, have created opportunities for creating novel industrial and healthcare based assets with improved sensing technology and which are capable of transmitting data that can then be distributed throughout a network. As a consequence, there are new opportunities to enhance the business value of some assets through the use of novel industrial-focused hardware and software.

In an industrial operating environment, a digital representation of an asset, referred to as a digital twin, can be made up of a variety of operational technology (OT) and information technology (IT) data management systems. Examples of OT data systems include data historian services which maintain a history of sensor data streams from sensors attached to an asset and monitoring systems that detect and store alerts and alarms related to potential fault conditions of an asset. Examples of IT data systems include enterprise resource planning (ERP) systems, maintenance record databases, and the like. Each of these systems operates in a narrow information silo with its own semantics, concerns and data storage models.

An industrial asset management application may attempt to aggregate these various sources of data into a centralized location in order to further process the data in an effort to help human operators observe issues with respect to an asset. From a network perspective, the IT and OT data systems can be thought of as comprising the network “edge” whereas the asset management application can be thought of as existing in the “cloud.” However, execution of processes on the edge and cloud are distinctly separated from one another. For example, in a typical asset management system, the cloud and the edge systems do no communicate directly with one another nor trigger control of one another. Instead, raw sensor data is transmitted from the edge (i.e., publishers) where it is stored by the cloud, and subsequently analyzed by systems (i.e., subscribers) in the cloud.

### SUMMARY

The example embodiments improve upon the prior art by providing a distributed fabric that seamlessly integrates a cloud runtime environment with an edge runtime environment enabling unified and seamless runtime integration between the cloud platform and the edge systems. The edge and the cloud systems may communicate with one another and control operation of the other. The distributed fabric is implemented based on an event model. Asynchronous messages generated by the cloud and the edge may be received by an event broker included within the fabric which processes the messages in a common manner regardless of whether they were generated by the cloud or the edge. Accordingly, developers and assets do not have to worry about the concerns of different runtime environments for assets at the edge and software and systems at the cloud. In some embodiments, the distributed fabric may be integrated within an Industrial Internet of Things (IIoT) which seamless connects the cloud with the edge.

According to an aspect of another example embodiment, a computing system may include one or more of a network interface configured to receive, via an integrated fabric, an asynchronous message from an edge system that is associated with an asset included on an edge of an Internet of Things (IoT) network, and a processor configured to determine an event to be executed with respect to a virtual asset in response to the received asynchronous message, the virtual asset being hosted by a cloud platform of the IoT network, and identifying input data for executing of the determined event based on parameters in the received asynchronous message, wherein the processor is further configured to trigger execution of the event at the virtual asset hosted by the cloud platform based on the identified input data.

According to an aspect of an example embodiment, a computer-implemented method may include one or more of receiving, by an integrated fabric, an asynchronous message from an edge system that is associated with an asset included on an edge of an IoT network, determining, by the integrated fabric, an event to be executed with respect to a virtual asset in response to the received asynchronous message, the virtual asset being hosted by a cloud platform of the IoT network, identifying, by the integrated fabric, input data for executing of the determined event based on parameters in the received asynchronous message, and triggering, by the integrated fabric, execution of the event at the virtual asset hosted by the cloud platform based on the identified input data.

Other features and aspects may be apparent from the following detailed description taken in conjunction with the drawings and the claims.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1 is a diagram illustrating a cloud computing environment in accordance with an example embodiment.

FIG. 2A is a diagram illustrating an event broker of a distributed integrated fabric in accordance with an example embodiment.

FIG. 2B is a diagram illustrating an asynchronous message for use by the distributed integrated fabric in accordance with an example embodiment.

FIG. 3A is a diagram illustrating an event broker receiving asynchronous messages in accordance with an example embodiment.

FIG. 3B is a diagram illustrating a process of the event broker triggering execution of processes based on messages in accordance with an example embodiment.

FIG. 4 is a diagram illustrating a method for triggering execution of an event via a distributed integrated fabric in accordance with an example embodiment.

FIG. 5 is a diagram illustrating a computing system in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a distributed fabric which seamlessly connects a cloud platform to the edge in an Internet of Things (IoT) network. For example, the cloud platform may host a digital twin (e.g. a contextual digital twin) or system of digital twins. The digital twin may virtually simulate operation of a device, a process, or system of devices and/or processes which are disposed within the IoT network. Edge systems include hardware and/or software which identifies and capture data sensed from by an edge device. The operating environment at the edge is typically distinct from an operating environment at the cloud. Here, edge systems generate raw sensor data which is then transferred to the cloud where it can be analyzed and processed for further action. However, the example embodiments go beyond data transfer between the edge and the cloud and establish a distributed integrated fabric which unifies a runtime environment between the edge systems and the cloud systems enabling the edge and the cloud to interact with each other.

The integrated fabric includes hardware and/or software at both edge systems and cloud systems which adheres to a common event model having an asynchronous messaging protocol. The fabric may include a network of computing nodes as well as software executing thereon. In this environment, the edge system and the cloud system can transmit asynchronous messages to an event broker within the fabric which receives the messages and triggers execution of processes in response. The asynchronous message protocol in combination with the event broker seamlessly integrates execution of processes by the edge and the cloud. Events triggered by the event broker can effect change in behavior of a cloud system such as a digital twin, and an edge system such as an asset, or the like. In this environment, the fabric can process events from both the edge and the cloud enabling both the edge and the cloud to communicate and control the other, directly.

The concept of a digital twin is well known, but prior digital twin technologies have focused on physics based modeling and machine learning analytics to create operational twins that can be used for failure prediction and error detection. The example embodiments can extend beyond that singular model and include a semantic-based digital twin model (referred to herein as the contextual digital twin) which can encompass a multiplicity of aspects of an asset, including structural models, physical process models, software process models, as well as modeling other entities in the environment such as people, organizations, facilities, etc. Because the model is semantic in nature, it can encompass hierarchies of assets and rich relationships (i.e., context) between the assets as well as between assets and other entities. The contextual aspect is derived from the further modeling of information, state and condition flows of the asset over time which provide a continual aggregation of knowledge about an asset an its environment. In this way, the contextual digital twin can provide a living model that drives business outcomes.

According to various aspects, a contextual digital twin may be used to virtually model an asset while also provide context that is associated with the asset. A digital twin may include a virtual representation of an asset which may include a virtual replication of hardware, software, processes, and the like. As an example, an asset may include a physical asset such as a turbine, jet engine, windmill, oil rig, healthcare machine, or the like. As another example, an asset may include a software asset (e.g., an application, an analytic, a service, etc.), a system of hardware and/or software (also referred to as a system of things), a physical process, an actor such as a human operator, weather, and the like. A contextual digital twin may include context of one or more of these assets incorporated within the virtual representation of the asset.

The context may be determined based on knowledge that is acquired from the asset (or the digital twin of the asset) and that is accumulated over time. For example, a digital twin may generate an alert or other warning based on a change in operating characteristics of the asset. The alert may be due to an issue with a component of the asset. In addition to the alert, the contextual digital twin may generate context that is associated with the alert. For example, the contextual digital twin may determine similar issues that have previously occurred with the asset or on assets that share one or more attributes in common with the asset, provide a description of what caused the issues, what was done to address the issues, and differences between the present issue and the previous issues, etc. As another non-limiting example, the generated context can provide suggestions about actions to take to resolve the current issue.

Assets may be outfitted with one or more sensors (e.g., physical sensors, virtual sensors, etc.) configured to monitor respective operations or conditions of the asset and the environment in which the asset operates. Data from the sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, enhanced software algorithms for operating the same or similar assets, better operating efficiency, and the like.

The contextual digital twin may be used in conjunction with applications and systems for managing machine and equipment assets and can be hosted within an Industrial Internet of Things (IIoT). For example, an IIoT may connect physical assets, such as turbines, jet engines, locomotives, healthcare devices, and the like, software assets, processes, actors, and the like, to the Internet or cloud, or to each other in some meaningful way such as through one or more networks. The system described herein can be implemented within a “cloud” or remote or distributed computing resource. The cloud can be used to receive, relay, transmit, store, analyze, or otherwise process information for or about assets. In an example, a cloud computing system includes at least one processor circuit, at least one database, and a plurality of users and assets that are in data communication with the cloud computing system. The cloud computing system can further include or can be coupled with one or more other processor circuits or modules configured to perform a specific task, such as to perform tasks related to asset maintenance, analytics, data storage, security, or some other function.

While progress with industrial and machine automation has been made over the last several decades, and assets have become ‘smarter,’ the intelligence of any individual asset pales in comparison to intelligence that can be gained when multiple smart devices are connected together, for example, in the cloud. Aggregating data collected from or about multiple assets can enable users to improve business processes, for example by improving effectiveness of asset maintenance or improving operational performance if appropriate industrial-specific data collection and modeling technology is developed and applied. The integration of machine and equipment assets with the remote computing resources to enable the IIoT often presents technical challenges separate and distinct from the specific industry and from computer networks, generally. To address these problems and other problems resulting from the intersection of certain industrial fields and the IIoT, the example embodiments provide a contextual digital twin that is capable of providing context in addition to a virtual representation of an asset. The context can be used to trigger actions, insight, and events based on knowledge that is captured and/or reasoned from the operation of an asset or a group of assets.

The Predix™ platform available from GE is a novel embodiment of such an Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial or healthcare based assets can be uniquely situated to leverage its understanding of assets themselves, models of such assets, and industrial operations or applications of such assets, to create new value for industrial customers through asset insights.

As described in various examples herein, data may include a raw collection of related values of an asset or a process including the asset, for example, in the form of a stream (in motion) or in a data storage system (at rest). Individual data values may include descriptive metadata as to a source of the data and an order in which the data was received, but may not be explicitly correlated. Information may refer to a related collection of data which is imputed to represent meaningful facts about an identified subject. As a non-limiting example, information may be a dataset such as a dataset which has been determined to represent temperature fluctuations of a machine part over time.

Knowledge may include a correlation or a set of correlations between a multiplicity of information elements, which may be represented as an ontologically defined relationship and which may reflect current or historic state or condition. Knowledge may include information about an asset or a resource, worker, artefact, or the like. A reasoned conclusion (or insight) may be automatically imputed by the system from generated knowledge. As a non-limiting example, an imputation may be that this person has read a particular document from which the assertion that the referenced person is aware of the existence of the particular document can be imputed. A domain event may refer to a particular type of knowledge artifact which models state or status of an entity in time, and which has event specific contextualizing semantics such as “this Actor took this Action with respect to this Entity in accordance with this Business Process at this Time.”

Context may refer to an accumulation of knowledge related to a subject (e.g., an asset, component of the asset, a case involving the asset, an event, etc.) which can be reasoned over to provide subject-specific insight. Context may be generated by acquiring knowledge with an intent to provide a specific solution or set of solutions for a particular problem or issue. As a non-limiting example, context about an asset provided with a digital twin may include insight such as similarly matching events and operations that have previously occurred to the asset (or similar type assets) as well as suggestions about how to handle a current event, and the like.

The contextual digital twin operates within the distributed integrated fabric as described according to various embodiments. The fabric unifies both the edge systems and a cloud system which hosts the contextual digital twin. The fabric may include a graph storage for storing templates of digital twins as graph constructs. The fabric may store a number of services which interact with the graph storage and which also execute the contextual digital twin within the common runtime environment. The execution of the contextual digital twin is invoked by programmatic behaviors which are simply referred to herein as “behaviors.” The integrated fabric enables the behaviors.

Behavioral programming is an approach to software development, which is aligned with how people often describe a systems' behavior. The behavioral application described herein may include methods or threads of behavior which may represent an independent scenario that the system should and/or shouldn't follow. The behaviors may be interwoven at run-time yielding integrated system behavior. Behaviors can include instantiating a contextual digital twin, configuring the contextual digital twin, operational behaviors triggering an action to the contextual digital twin, template behaviors, and the like. In addition, execution of a first behavior can trigger execution of additional behaviors. For example, instantiation of an assembly of a digital twin can recursively trigger instantiation of a sub-assembly of the digital twin which can further trigger instantiation of a component of the sub-assembly, and the like.

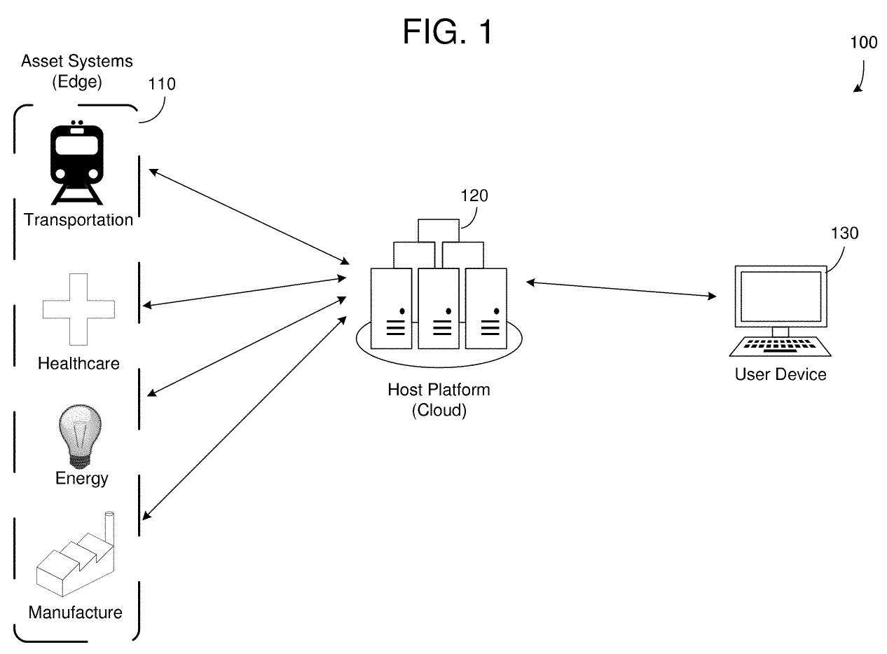

FIG. 1 illustrates a cloud computing system 100 for industrial software and hardware in accordance with an example embodiment. Referring to FIG. 1, the system 100 includes a plurality of assets 110 which may be included within an edge of an IIoT and which may transmit raw data to a source such as cloud computing platform 120 where it may be stored and processed. It should also be appreciated that the cloud platform 120 in FIG. 1 may be replaced with or supplemented by a non-cloud based platform such as a server, an on-premises computing system, and the like. Assets 110 may include hardware/structural assets such as machine and equipment used in industry, healthcare, manufacturing, energy, transportation, and that like. It should also be appreciated that assets 110 may include software, processes, actors, resources, and the like. A digital model (i.e., digital twin) of an asset 110 may be generated and stored on the cloud platform 120. The digital twin may be used to virtually represent an operating characteristic of the assets 110. The digital twin may also generate context associated with the operation of the asset 110 and output the context in a format that is capable of being consumed by an operator, a system, a software, etc. The data transmitted by the assets 110 and received by the cloud platform 120 may include raw time-series data output as a result of the operation of the assets 110, and the like. Data that is stored and processed by the cloud platform 120 may be output in some meaningful way to user devices 130. In the example of FIG. 1, the assets 110, cloud platform 120, and user devices 130 may be connected to each other via a network such as the Internet, a private network, a wired network, a wireless network, etc. Also, the user devices 130 may interact with software hosted by and deployed on the cloud platform 120 in order to receive data from and control operation of the assets 110.

Software and hardware systems can be used to enhance or otherwise used in conjunction with the operation of an asset and a digital twin of the asset (and/or other assets) may be hosted by the cloud platform 120 and may interact with the asset. For example, cloud systems may be used to optimize a performance of an asset or data coming in from the asset. As another example, the cloud systems may analyze, control, manage, or otherwise interact with the asset and components (software and hardware) thereof. A user device 130 may receive views of data or other information about the asset as the data is processed via one or more applications hosted by the cloud platform 120. For example, the user device 130 may receive graph-based results, diagrams, charts, warnings, measurements, power levels, and the like. As another example, the user device 130 may display a graphical user interface that allows a user thereof to input commands to an asset via one or more applications hosted by the cloud platform 120.

In some embodiments, an asset management platform (AMP) can reside within or be connected to the cloud platform 120, in a local or sandboxed environment, or can be distributed across multiple locations or devices and can be used to interact with the assets 110. The AMP can be configured to perform functions such as data acquisition, data analysis, data exchange, and the like, with local or remote assets, or with other task-specific processing devices. For example, the assets 110 may be an asset community (e.g., turbines, healthcare, power, industrial, manufacturing, mining, oil and gas, elevator, etc.) which may be communicatively coupled to the cloud platform 120 via one or more intermediate devices such as a stream data transfer platform, database, or the like.

Information from the assets 110 may be communicated to the cloud platform 120. For example, external sensors can be used to sense information about a function of an asset, or to sense information about an environment condition at or around an asset, a worker, a downtime, a machine or equipment maintenance, and the like. The external sensor can be configured for data communication with the cloud platform 120 which can be configured to store the raw sensor information and transfer the raw sensor information to the user devices 130 where it can be accessed by users, applications, systems, and the like, for further processing. Furthermore, an operation of the assets 110 may be enhanced or otherwise controlled by a user inputting commands though an application hosted by the cloud platform 120 or other remote host platform such as a web server. The data provided from the assets 110 may include time-series data or other types of data associated with the operations being performed by the assets 110

In some embodiments, the cloud platform 120 may include a local, system, enterprise, or global computing infrastructure that can be optimized for industrial data workloads, secure data communication, and compliance with regulatory requirements. The cloud platform 120 may include a database management system (DBMS) for creating, monitoring, and controlling access to data in a database coupled to or included within the cloud platform 120. The cloud platform 120 can also include services that developers can use to build or test industrial or manufacturing-based applications and services to implement IIoT applications that interact with assets 110.

For example, the cloud platform 120 may host an industrial application marketplace where developers can publish their distinctly developed applications and/or retrieve applications from third parties. In addition, the cloud platform 120 can host a development framework for communicating with various available services or modules. The development framework can offer developers a consistent contextual user experience in web or mobile applications. Developers can add and make accessible their applications (services, data, analytics, etc.) via the cloud platform 120. Also, analytic software may analyze data from or about a manufacturing process and provide insight, predictions, and early warning fault detection.

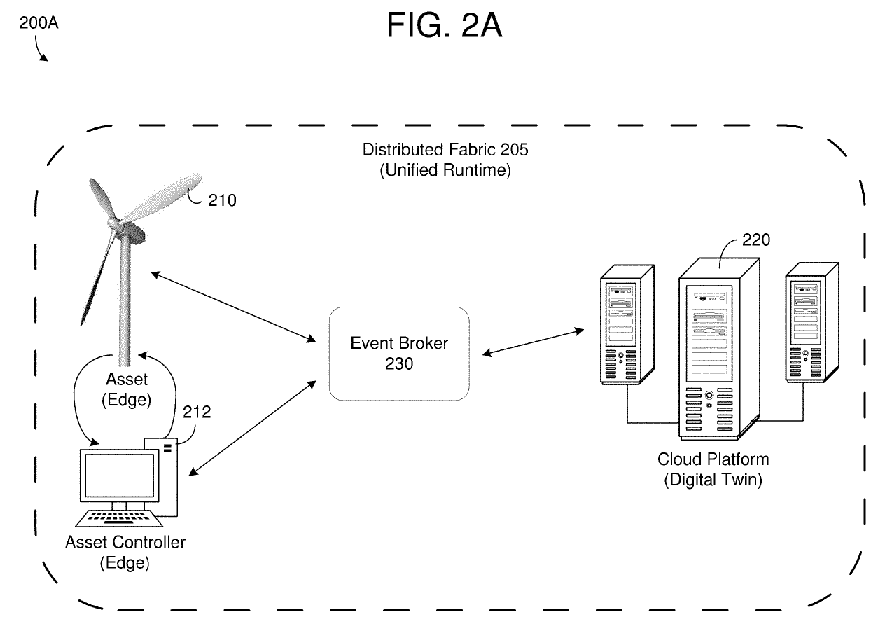

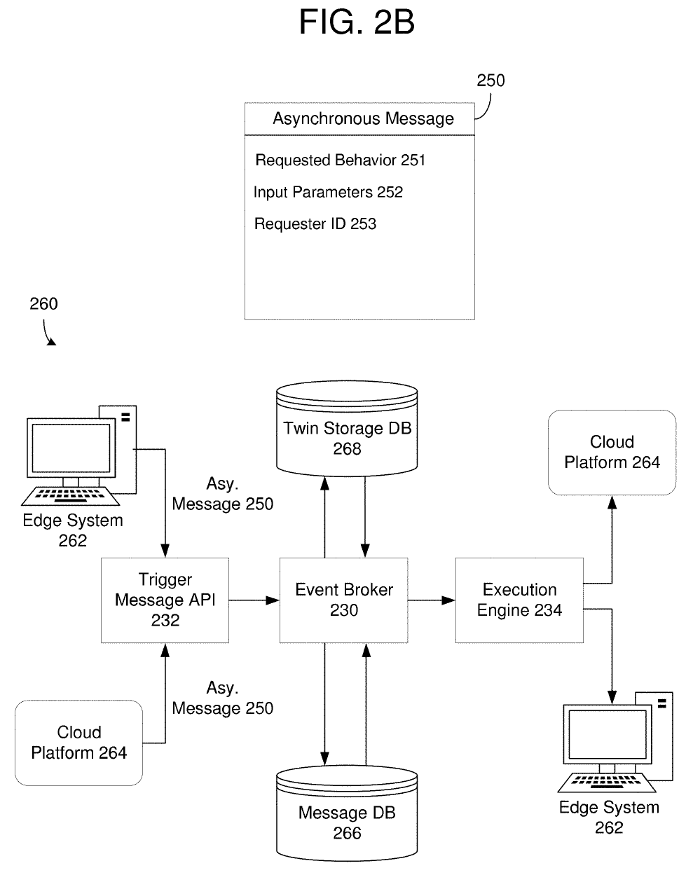

The cloud computing environment 100 shown in FIG. 1 may further include an integrated fabric system 200A shown in FIG. 2A. Referring to FIG. 2A, the system 200A includes a distributed integrated fabric 205 which unifies a runtime environment between an edge (e.g., asset 210, edge device 212, etc.) and a cloud platform 220 which are included within the system 200A. In this example, the edge includes an asset 210 such as a machine or equipment used in manufacture, healthcare, transportation, energy acquisition, and the like. The edge also includes an edge device 212 which may include an asset controller, an industrial PC, an industrial server, and/or the like. Meanwhile, the cloud platform 220 may host a contextual digital twin which is made up of software and hardware that simulates a virtual representation of one or more assets. The cloud platform 220 may also host conventional digital twins. As described herein, an asset may include a hardware machine, an equipment, a software process, an information resource, a system of assets, and the like.

The contextual digital twin is specified in terms of a model and a twin runtime environment. The runtime includes a twin storage and a distributed integrated fabric 205 as described herein. The twin storage provides persistence and access for twin artifacts or templates which are created in accordance with a twin ontology definition. The twin templates are naturally of the form of a graph, and thus, the twin runtime environment may be built around a graph database included within the twin storage. The twin storage, together with a set of services of the distributed integrated fabric 205 for creating, discovering, accessing and managing twin artifacts stored in the graph database are included in the twin runtime environment.

Within the distributed integrated fabric 205 is an event broker 205 which is configured to receive asynchronous messages from edge systems and cloud systems, and process the messages in a common manner. Messages may be transmitted from the edge and/or the cloud and may be used to trigger behaviors in one or more of the contextual digital twin and/or the edge devices/systems. The distributed integrated fabric 205 provides the principal connector between the edge 210/212, the cloud 220, the twin storage subsystem (not shown), etc., and is the primary supporting systems of the overall platform. The distributed integrated fabric 205 is the active element in the digital twin programming model. The fabric 205 may include an integrated fabric that seamlessly connects the cloud platform 220 hosting the digital twin and including the digital twin storage and the cloud edge where data is provided from the asset 210 or other source 212.

FIG. 2B illustrates a format of an asynchronous message 250 for use by the distributed integrated fabric in accordance with an example embodiment, and a process flow 260 of the event broker receiving messages and triggering events. Referring to FIG. 2B, the asynchronous message includes data for triggering a behavior to be executed with respect to one or more of a cloud system such as a digital twin, an asset, and the like. For example, the asynchronous message may include a behavior 251 which is being requested, input parameters 252, and a requester ID 253. The input parameters 252 may specific data, time frame, etc., to be used to process the behavior. The requester ID 253 may include an identification of the system that is transmitting the asynchronous message 250. As shown in process 260, any of an edge system 262 and a cloud system 264 may transmit an asynchronous message 250 to the distributed integrated fabric. In this example, the integrated fabric includes the event broker 230 as well as a trigger message application programming interface (API) service 232 for receiving trigger messages, and an execution engine service 234 for triggering execution of a behavior in response to receiving a trigger message. However, it should be appreciated that the services may be combined into a single service but are shown as separate services here for convenience only.

Prior to deployment of a contextual digital twin as a twin runtime instance, twin templates are designed and stored in a twin storage 268 which may include a twin graph storage that stores templates of digital twins as knowledge graphs. A twin builder application may create new twin templates, browse a marketplace of existing twin templates and acquire and customize them, and ultimately load such twin templates as instances within the runtime environment generated by the distributed integrated fabric.

The services 230, 232, and 234 may be stored in the distributed fabric and may be interconnected by a messaging bus. The services 230, 232, and 234 may persist records in the message database 266 which may be a SQL database, or the like. Trigger messages may be asynchronous and used to request a behavior be executed with respect to an instance of one or more digital twins in the runtime environment. The distributed fabric enables an event programming model which receives asynchronous trigger messages from both the cloud and the edge, and turns them into executed behaviors. For example, the trigger message service 232 may receive trigger messages via an API from the asset, a user interface, an application, a system, or the like, register the message, and create an entity in a database (not shown) for the trigger message. The trigger message has input parameters indicating data to be used during the execution of the behavior as well as token information that can be used to represent the trigger message.

The event broker 230 may be separated by a topic performs the job of looking at a capabilities object of each behavior bound to a digital twin template and determining if an instance of the digital twin is capable of performing the behavior included in the asynchronous trigger message. In some embodiments, the capabilities objects of all behaviors of each twin running in the runtime are cataloged in an index in advance rather than having to search through the entire graph database. The event broker 230 may match a trigger message up to a capabilities object that advertise the trigger message to which a twin behavior is responsive. For example, the event broker 230 may determine that a behavior listed in a trigger message is associated with specific template elements in various templates of multiple digital twins.

The event broker 230 may examine a policy object associated with the behavior to determine whether the behavior can be executed at that time based on context associated with the digital twin. For example, the behavior may include certain parameters indicating situations when the behavior can be executed and situations when the behavior can't be executed based on context. The policy (business rule) may also change the action of the behavior. For example, parameters of a behavior may be policy generated and fed into the behavior to add to the input parameters. The event broker 230 may also determine input parameters to use (parsing) and validate that they are valid values for the input parameters by comparing the values to a requirements object of the behavior. The requirements object advertises what inputs are needed to run this behavior, what the values are of the inputs, etc.

Each behavior may include a capabilities object identifying trigger messages which cause the behavior to execute, a polity object identifying business rules when and where the behavior can execute, and a requirements object identifying values of input parameters that are needed to execute the behavior. If the event broker 230 validates the performance of a behavior, the event broker 230 may create a skill execution record which will contain the work product of the behavior and generate an executable script which is sent by a message to the execution engine service 234 which runs the script/executable. The executable part of the behavior may have pieces that are re-usable across different behaviors. The event broker 230 triggers execution of the behavior. Here, the behavior can create an effect on the digital twin (e.g., cloud platform 264), the asset (e.g., edge system 262), or the like.

The runtime environment works in conjunction with the templates and behaviors to enable the behavioral functionality of the contextual digital twin. The message database 266 is stored in the fabric and may include a database (e.g., SQL, Blob, etc.) that stores the artifacts of the requests coming in. Meanwhile, the twin storage 268 may include a graph store where the contextual digital twin models live within the runtime environment. The twin storage 268 may store templates of digital twins as graph constructs. If a user owns a digital twin template wants to create a new instance, the user may select a button through a user interface which can send a request (trigger message) to the distributed fabric to instantiate a digital twin of this type with these identifiers.

For example, a behavior associated with the instantiation with a particular template may be registered with the fabric (publish/subscribe) to hear specific requests. When the event broker 230 receives one of these requests it can starts a chain of behaviors that produce the instance of the digital twin. In this example, a first behavior may pull all of the data needed to instantiate a digital twin instance. This behavior may also trigger some additional requests (recursive tree) which trigger a next behavior with some new information which is picked up by the next layer down in the recursive tree of the graph of the digital twin template. Each individual element of the digital twin instance has a behavior to generate itself. All of the instances elements are created based on graph model of the digital twin template. The behaviors continue to be triggered throughout the graph until all assemblies, sub-assemblies, and components of the digital twin are generated. The result is an instance tree of the specific data of the specific elements of the asset. The next request (trigger message) may be a configuration request which looks at the instance and knows how to deploy the necessary analytics into the fabric (e.g., edge gateway).

The contextual digital twin template aspect of the example embodiments is a significant differentiator from previously known knowledge graph or asset model approaches. Twin templates are designed graph constructs which are intended to provide or encapsulate various capabilities. For example, the template may have a pragmatic entity structure. Here, the template may model the structure (hardware/software/process) of the twinned entity to a degree necessary to accomplish the purposes of the digital twin platform. So, for example, whereas known Asset Models are intended to provide a detailed and comprehensive structural breakdown of an asset, the twin template might only go to the depth of identifying components that provide data or participate in a defined physical processes. The template also provides a mechanism for creating instance Models (see twin instance elements below) corresponding to real world instances of a particular asset. The template provides a container for all behaviors associated with the operation of a digital twin instance.

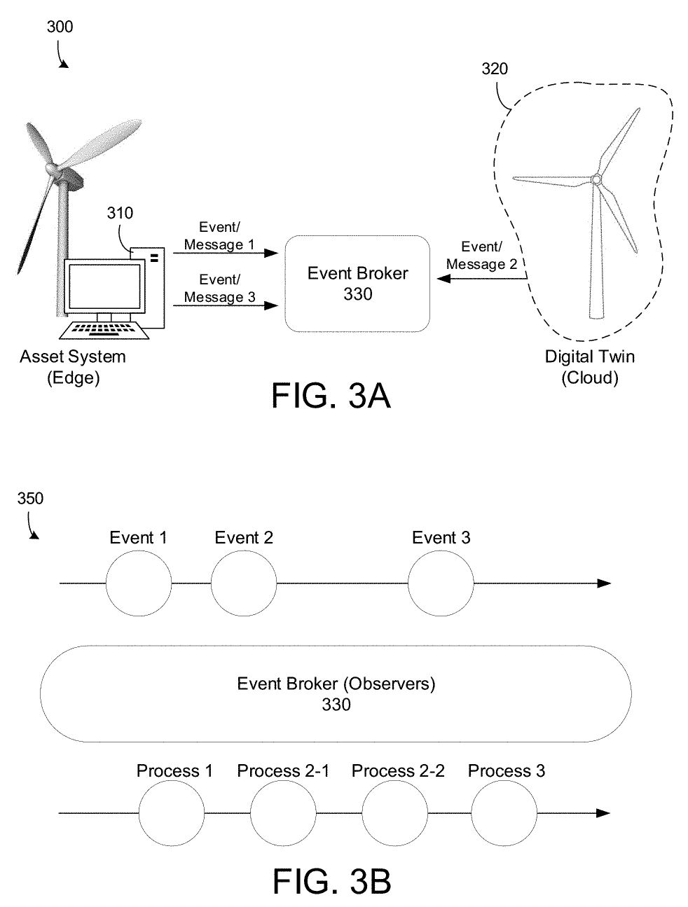

FIG. 3A illustrates an event broker 330 receiving asynchronous messages in accordance with an example embodiment, and FIG. 3B illustrates a process 350 of the event broker 330 triggering execution of processes based on the messages in accordance with an example embodiment. As shown in this example, the event broker 330 receives three asynchronous messages (two from the edge and one from the cloud). In this example, the event broker triggers execution of events/behaviors based on the order in which the asynchronous message requests are received. That is, the event broker 330 implements a first-in first-out event processing protocol. As shown in the marble diagram of FIG. 3B, each message triggers execution of one or more processes. For example, in response to receiving the first message from the edge 310, the event broker 330 triggers execution of a first event. In response to receiving the second message from the cloud 320, the event broker 330 triggers execution of a second process which subsequently triggers execution of a sub process of the second process. Next, the event broker triggers execution of a third process in response to the third message from the edge 310.

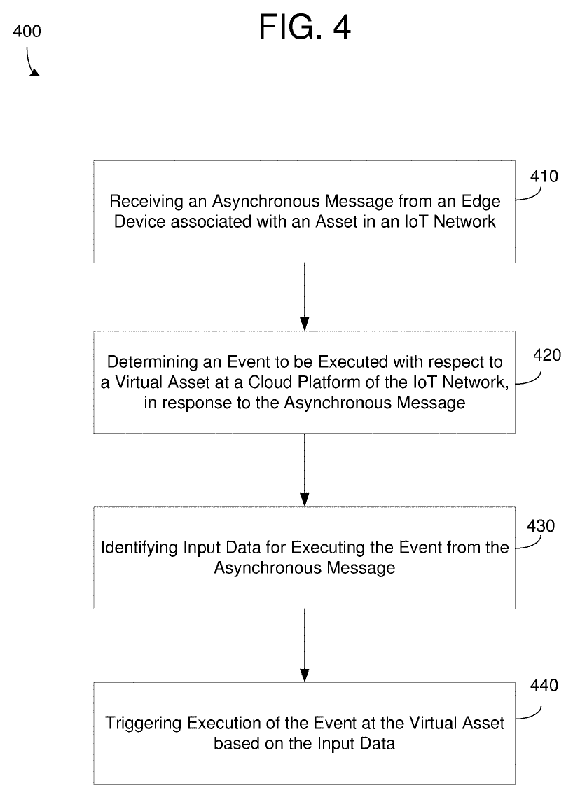

FIG. 4 illustrates a method 400 for triggering an event via a distributed integrated fabric in accordance with an example embodiment. For example, the method 400 may be performed by one or more of a computing node, a cloud instance, a computer, a user device, a processing device, a stream processor, a database, a combination of devices, and the like, which may be part of or otherwise connected to a distributed integrated fabric. Referring to FIG. 4, in 410, the method includes receiving an asynchronous message from an edge device that is associated with an asset included on an edge of an Internet of Things (IoT) network.

For example, the asynchronous message may be based on a messaging model that is configured for use by both the edge device and the cloud platform for communicating with the integrated fabric. In this example, the integrated fabric unifies a runtime environment of the edge and a runtime environment of the cloud platform in the IoT network. As a non-limiting example, an edge device may include one or devices that are included an edge environment such as an asset, a computing system coupled to the asset, an industrial computing system, an asset controller computing system, an edge server, and the like. Meanwhile, the cloud may include one or more of software and hardware for executing cloud-based systems such as a contextual digital twin.

In 420, the method includes determining an event to be executed with respect to a virtual asset in response to the received asynchronous message. In this example, the virtual asset may be a digital twin of the asset and may be hosted by a cloud platform of the IoT network. The asynchronous message may include one or more processing events listed therein, and an identification of one or more digital twins that are associated with the processing event. The fabric may determine which digital twins are linked to the asynchronous message, for example, based on a capabilities object of the digital twins stored in template thereof.

As an example, the event may include one or more of launching or otherwise initiating an instance of the virtual asset via the cloud platform. As another example, the event may include triggering an alert via the virtual asset based on an alert associated with the asset which is received from the edge device. As another example, the event may include determining context associated with the asset that is to be modeled with respect to the virtual asset. In some embodiments, the receiving may further include receiving an asynchronous message from the virtual asset hosted by the cloud platform and determining an order for processing the asynchronous message from the edge device and the asynchronous message from the virtual asset based on an order in which the asynchronous messages are received.

In 430, the method includes identifying, by the integrated fabric, input data for executing the determined event based on parameters included in the received asynchronous message. As an example, the input data may include parameters (sensor data, time-series data, asset identification, part IDs, materials, etc.) from or of the asset which are to be modeled via the virtual asset, an alert message, inputs for a behavioral programming construct, and the like. In 440, the method includes triggering, by the integrated fabric, execution of the event at the virtual asset hosted by the cloud platform based on the identified input data. The triggering may cause the event to be executed and to effect a change in a behavior of the virtual asset based on the event received from the edge device.

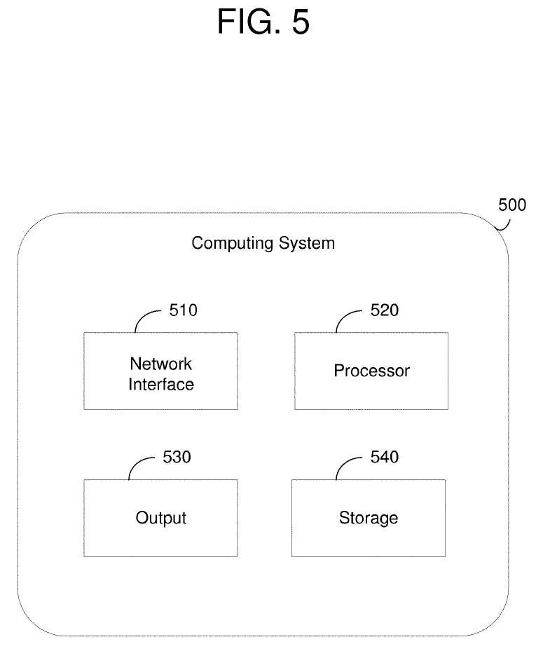

FIG. 5 illustrates a computing system 500 in accordance with an example embodiment. For example, the computing system 500 may be a cloud platform (or instance thereof), a streaming platform, a user device, and the like. As a non-limiting example, the computing system 500 may be the cloud platform 120 shown in FIG. 1. In some embodiments, the computing system 500 may be distributed across multiple devices. Also, the computing system 500 may perform the method 400. Referring to FIG. 5, the computing system 500 includes a network interface 510, a processor 520, an output 530, and a storage device 540 such as a memory. Although not shown in FIG. 5, the computing system 500 may include other components such as a display, an input unit, a receiver, a transmitter, an application programming interface (API), and the like, all of which may be controlled or replaced by the processor 520.

The network interface 510 may transmit and receive data over a network such as the Internet, a private network, a public network, and the like. The network interface 510 may be a wireless interface, a wired interface, or a combination thereof. The processor 520 may include one or more processing devices each including one or more processing cores. In some examples, the processor 520 is a multicore processor or a plurality of multicore processors. Also, the processor 520 may be fixed or it may be reconfigurable. The output 530 may output data to an embedded display of the computing system 500, an externally connected display, a display connected to the cloud, another device, and the like. The storage device 540 is not limited to a particular storage device and may include any known memory device such as RAM, ROM, hard disk, and the like, and may or may not be included within the cloud environment. In some embodiments, the storage 540 may include a graph database for storing templates of contextual digital twins and the associated elements thereof. The storage 540 may store software modules or other instructions which can be executed by the processor 520 to perform the methods described herein.

According to various embodiments, the network interface 510 may receive, via an integrated fabric, an asynchronous message from an edge system that is associated with an asset included on an edge of an IoT network. The processor 520 may determine an event to be executed with respect to a virtual asset in response to the received asynchronous message. In this example, the virtual asset may be hosted by a cloud platform of the IoT network while the edge system is disposed on an edge of the IoT network. The processor 520 may identify input data for executing of the determined event based on parameters in the received asynchronous message, and trigger execution of the event at the virtual asset hosted by the cloud platform based on the identified input data.

As described herein, the asynchronous message may include a messaging model that is configured for use by both the edge system and the cloud platform for communicating with the integrated fabric. The message may include an identification of an event that is to be triggered as well as an identification of one or more digital twins, edge devices, and the like, which are to perform the event. The integrated fabric unifies a runtime environment of the edge and a runtime environment of the cloud platform in the IoT network. In some embodiments, the network interface 510 may receive an asynchronous message from the virtual asset hosted by the cloud platform and the processor 520 may determine an order for processing the asynchronous message from the edge system and the asynchronous message from the virtual asset based on an order in which the asynchronous messages are received (i.e., first-in first-out).

The event may generate a change or cause an effect to a digital twin. For example, the processor 520 may launch the virtual asset via the cloud platform, as the event. As another example, the processor 520 may determine an alert to trigger via the virtual asset based on an alert associated with the asset which is received from the edge system, as the event. As another example, the processor 520 may determine context associated with the asset that is to be modeled with respect to the virtual asset, as the event. Events can also be used to provide context to a user via a user interface such as an identification of similar assets having similar operational characteristics.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing system comprising:
a network interface configured to receive, via an integrated fabric, an asynchronous message from an edge system that is associated with an asset included on an edge of an Internet of Things (IoT) network; and
a processor configured to determine an event to be executed with respect to a virtual asset in response to the received asynchronous message, the virtual asset being hosted by a cloud platform of the IoT network, and identifying input data for executing of the determined event based on parameters in the received asynchronous message, wherein the processor is further configured to trigger execution of the event at the virtual asset hosted by the cloud platform based on the identified input data.

2. The computing system of claim 1, wherein the asynchronous message comprises a messaging model that is configured for use by both the edge system and the cloud platform for communicating with the integrated fabric.

3. The computing system of claim 1, wherein the integrated fabric unifies a runtime environment of the edge and a runtime environment of the cloud platform in the IoT network.

4. The computing system of claim 1, wherein the edge system comprises one or more of the asset, a computing system coupled to the asset, an industrial computing system, an asset controller computing system, and an edge server.

5. The computing system of claim 1, wherein the network interface is further configured to receive an asynchronous message from the virtual asset hosted by the cloud platform and the processor is further configured to determine an order for processing the asynchronous message from the edge system and the asynchronous message from the virtual asset based on an order in which the asynchronous messages are received.

6. The computing system of claim 1, wherein the processor is configured to determine to launch the virtual asset via the cloud platform, as the event.

7. The computing system of claim 1, wherein the processor is configured to determine an alert to trigger via the virtual asset based on an alert associated with the asset which is received from the edge system, as the event.

8. The computing system of claim 1, wherein the virtual asset is a digital replica of the asset, and the processor is configured to determine the event by determining context associated with the asset that is to be modeled with respect to the virtual asset.

9. A computer-implemented method comprising:
receiving, by an integrated fabric, an asynchronous message from an edge system that is associated with an asset included on an edge of an Internet of Things (IoT) network;
determining, by the integrated fabric, an event to be executed with respect to a virtual asset in response to the received asynchronous message, the virtual asset being hosted by a cloud platform of the IoT network;
identifying, by the integrated fabric, input data for executing of the determined event based on parameters in the received asynchronous message; and
triggering, by the integrated fabric, execution of the event at the virtual asset hosted by the cloud platform based on the identified input data.

10. The computer-implemented method of claim 9, wherein the asynchronous message comprises a messaging model that is configured for use by both the edge system and the cloud platform for communicating with the integrated fabric.

11. The computer-implemented method of claim 9, wherein the integrated fabric unifies a runtime environment of the edge and a runtime environment of the cloud platform in the IoT network.

12. The computer-implemented method of claim 9, wherein the edge system comprises one or more of the asset, a computing system coupled to the asset, an industrial computing system, an asset controller computing system, and an edge server.

13. The computer-implemented method of claim 9, wherein the receiving further comprises receiving an asynchronous message from the virtual asset hosted by the cloud platform and determining an order for processing the asynchronous message from the edge system and the asynchronous message from the virtual asset based on an order in which the asynchronous messages are received.

14. The computer-implemented method of claim 9, wherein the determining the event to be executed comprises determining to launch the virtual asset via the cloud platform.

15. The computer-implemented method of claim 9, wherein the determining the event comprises determining an alert to trigger via the virtual asset based on an alert associated with the asset which is received from the edge system.

16. The computer-implemented method of claim 9, wherein the virtual asset is a digital replica of the asset, and the determining the event comprises determining context associated with the asset that is to be modeled with respect to the virtual asset.

17. A non-transitory computer readable medium having stored therein instructions that when executed cause a computer to perform a method comprising:
receiving, by an integrated fabric, an asynchronous message from an edge system that is associated with an asset included on an edge of an Internet of Things (IoT) network;
determining, by the integrated fabric, an event to be executed with respect to a virtual asset in response to the received asynchronous message, the virtual asset being hosted by a cloud platform of the IoT network;
identifying, by the integrated fabric, input data for executing of the determined event based on parameters in the received asynchronous message; and
triggering, by the integrated fabric, execution of the event at the virtual asset hosted by the cloud platform based on the identified input data.

18. The non-transitory computer readable medium of claim 17, wherein the asynchronous message comprises a messaging model that is configured for use by both the edge system and the cloud platform for communicating with the integrated fabric.

19. The non-transitory computer readable medium of claim 17, wherein the integrated fabric unifies a runtime environment of the edge and a runtime environment of the cloud platform in the IoT network.

20. The non-transitory computer readable medium of claim 17, wherein the receiving further comprises receiving an asynchronous message from the virtual asset hosted by the cloud platform and determining an order for processing the asynchronous message from the edge system and the asynchronous message from the virtual asset based on an order in which the asynchronous messages are received.
